(19) United States
(12) Patent Application Publication
(10) Pub. No.: US 2003/0234062 A1
(43) Pub. Date: Dec. 25, 2003

(54) CAN WITH PREDETERMINED OUTPUT QUANTITY

(76) Inventor: Huan Kuei Wei, Taipei (TW)

Correspondence Address: Huan Kuei Wei, 235 Chung-Ho, Box 8-24, Taipei, TW

(21) Appl. No.: 10/174,863

(22) Filed: Jun. 20, 2002

(51) Int. Cl. B67C 3/00

(52) U.S. Cl. 141/319; 141/22; 141/380

(57) ABSTRACT

A can with a predetermined output quantity comprises a can body, a positioning ring, a rotatable cover, and a receiving spoon. The can body has a flange which is engagable with a trench in the rotatable cover. An interior of the can body has a plurality of grooves. A bottom of the receiving spoon is protruded with a circular buckling flange. A diameter of the circular buckling flange is slightly smaller than an inner diameter of a U shape track of the rotatable cover. Thereby, the receiving spoon is embedded into the U shape track to be confined therein. A hollow end of the receiving spoon is exactly aligned to the through hole of the rotatable cover. Thus, the height of the receiving spoon is adjustable so that the user can take a predetermined amount of powders or materials in the can conveniently.

### FIELD OF THE INVENTION

The present invention relates to cans, and particularly to a can with a predetermined output quantity. The height of the receiving spoon is adjustable so that the user can take a predetermined amount of powders or materials in the can conveniently.

### BACKGROUND OF THE INVENTION

In general, powders are filled into a can by using a spoon and then the powders are filled into the can. Then the cover of the can is screwed tightly to the can. In use, a spoon in the can is taken out, but this action will induce that the power in the can is also taken out with the spoon so as to pollute the periphery of the can. However, this is not economic.

Moreover, if the length of the spoon is too short and only a small amount powders in the can, the user's fingers must to insert into the can. Not only the operation is inconvenient, but also the fingers are polluted by the powders. This makes a trouble to the users.

### SUMMARY OF THE INVENTION

Accordingly, the primary object of the present invention is to provide a can with a predetermined output quantity, wherein the height of the receiving spoon is adjustable so that the user can take a predetermined amount of powders or materials in the can conveniently.

To achieve the object, the present invention provide a can with a predetermined output quantity comprises a can body, a positioning ring, a rotatable cover, and a receiving spoon. The can body has a flange which is engagable with a trench in the rotatable cover. An interior of the can body has a plurality of grooves. A bottom of the receiving spoon is protruded with a circular buckling flange. A diameter of the circular buckling flange is slightly smaller than an inner diameter of a U shape track of the rotatable cover. Thereby, the receiving spoon is embedded into the U shape track to be confined therein. A hollow end of the receiving spoon is exactly aligned to the through hole of the rotatable cover.

The various objects and advantages of the present invention will be more readil understood from the following detailed description when read in conjunction with the appended drawing.

### BRIEF DESCRIPTION OF THE DRAWINGS

FIG. 1 is an exploded perspective view of the present invention.

FIG. 1A is a cross sectional view of the present invention.

FIG. 2 is an assembled perspective view of the present invention.

FIG. 3A is a plane view showing the normal condition of the present invention.

FIG. 3B is a plane view showing that the present invention is an in inverse status.

FIG. 3C is a plane view showing that the spoon of the present invention is taken out.

### DETAILED DESCRIPTION OF THE PREFERRED EMBODIMENTS

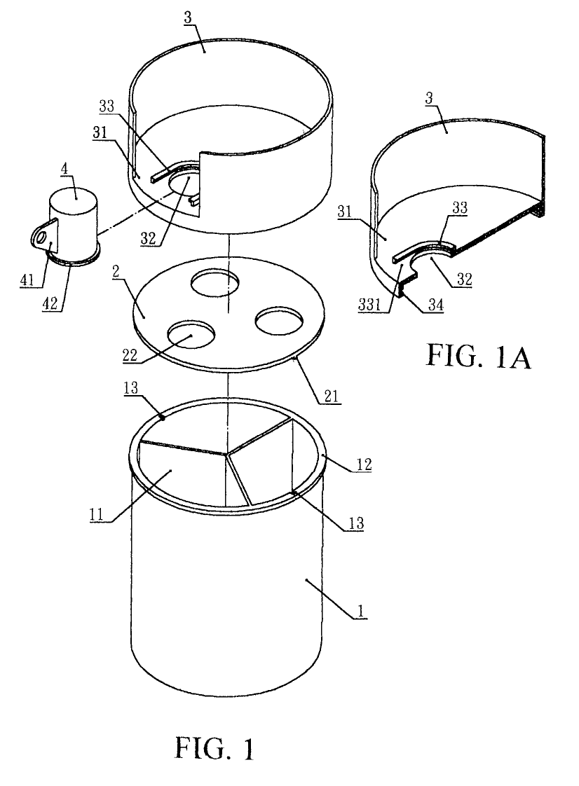

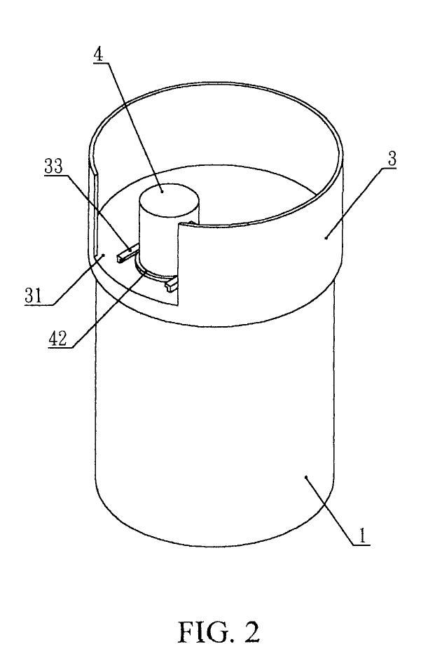

Referring to FIGS. 1 and 2, the structure of the present invention is illustrated. The present invention is mainly formed by a can body 1, a positioning ring 2 buckled to the can body 1, a rotatable cover 3 at the topmost of the can body 1, and a receiving spoon 4 buckled to the rotatable cover 3.

The can body 1 is a round cylindrical body. The interior of the can body 1 has a plurality of grooves 11 for placing powders or materials. A flange 12 extends from a top of the can body 1. An embedding groove 13 is formed at the interior of the flange 12.

The surface of the positioning ring 2 has a buckling block 21 at a position for being buckled to the embedding groove 13. The end surface of the positioning ring 2 is installed a plurality of via holes 22 for being passed by powders or materials.

The surface of the rotatable cover 3 has a hollow hole 31. A through hole 32 is formed beside the hollow hole 31. A periphery of the through hole 32 has a U shape track 33. A cross section of the U shape track 33 has an inverse L shape. An opening 331 of the U shape track 33 is aligned to the via hole 31 of the rotatable cover 3. A bottom surface of the rotatable cover 3 has a circular trench 34 which exactly resists against the flange 12 of the can body 1. Thereby, the rotatable cover 3 is rotatable on the can body 1.

A top of the receiving spoon 4 is closed and a bottom thereof is hollowed and a lateral side of the receiving spoon 4 has a pull piece 41. A bottom of the receiving spoon 4 is protruded with a circular buckling flange 42. A diameter of the circular buckling flange is slightly smaller than an inner diameter of the U shape track 33 of the rotatable cover 3. Thereby, the receiving spoon 4 can be embedded into the opening 331 of the U shape track 33 to be confined in the inverse L shape of the U shape track 33. The hollow end of the receiving spoon 4 is exactly aligned to the through hole 32 of the rotatable cover 3.

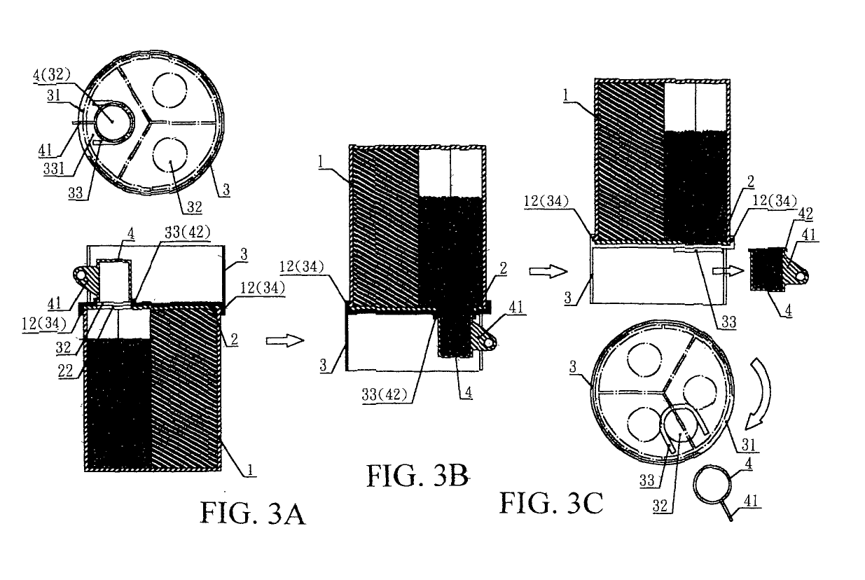

Referring to FIG. 3, a plane view for showing the operation of the present invention is illustrated. When the user is desired to take powders from the can, the receiving spoon 4 can be embedded into the U shape track 33 of the rotatable cover 3 in advance, and then the rotatable cover 3 rotates. Then, the positioning ring 2 will buckle the top edge of the can body 1 by the buckle block 21 thereof without rotation with the rotatable cover 3. When the rotatable cover 3 drives the receiving spoon 4 to rotate synchronously to cause the through hole 32 of the rotatable cover 3 to be aligned with the via hole 22 of the positioning ring 2 (referring to FIG. 3A). Then the can is fallen down so that the powders pass through the via hole 22 of the positioning ring 2 and the through hole 32 of the rotatable cover 3 to enter into the receiving spoon 4 (referring to FIG. 3B). Then, the rotatable cover 3 is rotated through a proper angle so that the through hole 32 of the rotatable cover 3 is not communicated with the via hole 22 of the positioning ring 2. Then the receiving spoon 4 is taken out by standing the can upside down (now the hollow portion of the receiving spoon 4 is at an upper side). After the receiving spoon 4 is taken out, the via hole 22 of the positioning ring 2 is stopped by the rotatable cover 3. The powders or materials in the can body 1 will no fall out so that each time, the user may take a predetermined amount of powders or materials (referring to FIG. 3C) conveniently.

The height of the receiving spoon 4 is adjusted as desired so that the user may take different amount of powders or materials.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A can with a predetermined output quantity; the can comprising a can body, a positioning ring buckled to an upper edge of the can body, a rotatable cover at a topmost of the can body, and a receiving spoon buckled to the rotatable cover; wherein
an interior of the can body has a plurality of grooves; a body flange extends from a top of the can body; an embedding groove is formed at an edge of the body flange;
a surface of the positioning ring has a buckling block at a position capable of being buckled to the embedding groove; an end surface of the positioning ring is installed a plurality of via holes;
a surface of the rotatable cover has a hollow hole; a through hole is formed beside the hollow hole; a periphery of the through hole has a U shape track; a bottom surface of the rotatable cover has a circular trench which exactly resists against the body flange of the can body; and
a bottom of the receiving spoon is protruded with a circular buckling flange; a diameter of the circular buckling flange is slightly smaller than an inner diameter of the U shape track of the rotatable cover; thereby, the receiving spoon is embedded into the U shape track to be confined therein; a hollow end of the receiving spoon is exactly aligned to the through hole of the rotatable cover;
thereby, the height of the receiving spoon is adjustable so that the user can take a predetermined amount of powders or materials in the can conveniently.

2. The can with a predetermined output quantity as claimed in claim 1, wherein a cross section of the U shape track has an L shape cross section; a top of the receiving spoon is closed and a bottom thereof is hollowed; the receiving spoon is a cylinder with a pull piece at a lateral side thereof; and the receiving spoon is embedded into the U shape track to be-confined in the U shape track.

3. The can with a predetermined output quantity as claimed in claim 1, wherein a height of the receiving spoon is adjustable so that the output amount from the can is adjustable with the height of the can.

4. The can with a predetermined output quantity as claimed in claim 1, wherein the can body has a plurality of grooves for receiving various kinds of materials.
